(19) United States
(12) Patent Application Publication
(10) Pub. No.: US 2004/0051599 A1
(43) Pub. Date: Mar. 18, 2004

(54) Method and apparatus for producing time-delayed microwave signals

(76) Inventors: Donald G. Marion, Amherst, NH (US); Annemarie Giza, Amherst, NH (US)

Correspondence Address: Laurence S. Roach, Esq., Jaeckle Fleischmann & Mugel, LLP, 39 State Street, Suite 200, Rochester, NY, 14614-1310, US

(21) Appl. No.: 10/244,576

(22) Filed: Sep. 16, 2002

(51) Int. Cl. H01P 1/18

(52) U.S. Cl. 333/164

(57) ABSTRACT

A scanned antenna array includes time delay stages each having at least one time delay sub-circuit. Each time delay sub-circuit includes a sub-circuit input, a sub-circuit output, a first delay line, and a second delay line. A first diode switch connects a first end of a selected one of the first and second delay lines to the sub-circuit input. A second diode switch connects a second end of the selected one of the first and second delay lines to the sub-circuit output. The sub-circuit output is connected to one of another time delay sub-circuit or to an output of the time delay stage. A respective transmit/receive (TR) module is coupled to an output of each time delay stage and issues a TR module output signal. A plurality of antenna elements radiate an output signal received from the corresponding TR module.

### FIELD OF THE INVENTION

The present invention relates generally to a method and apparatus for producing time delayed microwave signals for directional antenna beam patterning.

### DESCRIPTION OF THE RELATED ART

Many modern electronic systems, such as systems for radar, communication and electronic countermeasures, utilize an electrically scanned antenna array. Scanned antenna arrays provide each antenna element with a signal from a time delay and/or phase shifting circuit such that each antenna element receives a signal that is slightly shifted in time and/or phase relative to the other antenna elements. The time-delayed or phase-shifted signals electronically form or shape the signal emitted from the antenna array into a desired pattern of radiation, sometimes referred to as a beam. The beam focuses the emitted signal to a desired location or in a desired direction.

Such time delay circuits typically include multiple stages, or sub-circuits, that are cascaded together (i.e., connected in series). Each sub-circuit includes a divider that routes the microwave signal through a reference line and a delay line. The delay line has a length that is a predetermined amount greater than the reference line, and thus the propagation time of the microwave signal through the delay line is delayed relative to the propagation time of the microwave signal through the reference line. The delay lines of the sub-circuits are typically arranged in binary sequence, such that the length of the delay lines in each sub-circuit increases according to the ratio of 1, 2, 4 . . . , 2ⁿ, and such a delay circuit is therefore sometimes referred to as a digital delay circuit. A switch in each sub-circuit selectively connects either the reference line or the delay line to an amplifier. The amplifier interfaces that sub-circuit with the next cascaded sub-circuit, and thus either the reference microwave signal or the delayed microwave signal is amplified and passed to the next sub-circuit.

The switches are typically discrete P-type semiconductor/Intrinsic/N-type semiconductor (PIN) diode switches, which have relatively predictable time delays and low insertion losses. However, discrete PIN diode switches have a limited operating frequency band and are relatively costly to produce in the quantities required. Further, such discrete PIN diode switches consume large amounts of space compared to integrated circuit devices. The amplifier in each time delay sub-circuit amplifies the microwave signal by a predetermined amount to compensate for the insertion losses of the switch and divider. However, the amplifiers render the delay circuit non-reciprocal (i.e., directional), and add complexity and cost to the device.

Each sub-circuit of a conventional delay circuit typically includes multiple discrete components, such as discrete PIN diodes configured as switches and including inductors, capacitors and resistors. Each of the components used in the sub-circuit, besides consuming relatively large amounts of space, have known and inherent characteristics and properties that can degrade performance. The circuits may require manual tuning in order to achieve and maintain acceptable overall performance of the system. Manually tuning the delay circuits is time consuming, and is not a process with high repeatability. Therefore, a relatively large degree of variation is likely to exist between the operating characteristics of different delay circuits, and extensive screening, testing and matching of delay circuits is likely to be required.

Since the sub-circuits are typically cascaded, any degradation in the performance of one sub-circuit is multiplied by the subsequent sub-circuits. Isolation devices are inserted between the sub-circuits to reduce the amount of degradation and/or error that is passed from one sub-circuit to a subsequent sub-circuit, thereby reducing the magnification of the degrading characteristics by the subsequent sub-circuit. However, isolation devices also render the delay circuit uni-directional or non-reciprocal, add complexity to the circuit, reduce the useable bandwidth, and make the circuit difficult to tune.

Therefore, what is needed in the art is a microwave time delay circuit that reduces the need for manual tuning.

Furthermore, what is needed in the art is a microwave time delay circuit that has a reduced number of discrete components relative to a conventional microwave time delay circuit.

Still further, what is needed in the art is a microwave time delay circuit that has an increased useable bandwidth relative to a conventional microwave time delay circuit.

Even further, what is needed in the art is a microwave time delay circuit having improved performance and repeatability in manufacture.

Yet further, what is needed in the art is a microwave delay circuit that eliminates the dividers and the insertion losses associated therewith.

Moreover, what is needed in the art is a microwave delay circuit that eliminates the need for an interfacing amplifier between stages.

Lastly, what is needed in the art is a microwave delay circuit that is reciprocal.

### SUMMARY OF THE INVENTION

The present invention provides a method and apparatus for producing time-delayed microwave signals.

The invention comprises, in one form thereof, one or more time delay stages each having at least one time delay sub-circuit. Each time delay sub-circuit includes a sub-circuit input, a sub-circuit output, a first delay line, and a second delay line. A first diode switch connects a first end of a selected one of the first and second delay lines to the sub-circuit input. A second diode switch connects a second end of the selected one of the first and second delay lines to the sub-circuit output. The sub-circuit output is connected to one of another time delay sub-circuit or to an output of the time delay stage. A respective transmit/receive (TR) module is coupled to an output of each time delay stage and issues a TR module output signal. A plurality of antenna elements radiate the TR module output signals.

An advantage of the present invention is that the need for manual tuning of the delay stages and/or sub-circuits is substantially reduced.

Another advantage of the present invention is the number of discrete components is substantially reduced relative to a conventional microwave time delay circuit.

Yet another advantage of the present invention is the useable bandwidth is substantially increased relative to a conventional microwave time delay circuit.

A further advantage of the present invention is the delay stages and/or sub-circuits have improved performance and repeatability in manufacture.

An even further advantage of the present invention is the use of dividers is eliminated, and thus the insertion losses associated therewith are also eliminated.

A still further advantage of the present invention is there is no need for an interfacing amplifier between delay stages and/or sub-circuits.

Yet a further advantage of the present invention is that the delay stages and/or sub-circuits are reciprocal.

Other advantages of the present invention will be obvious to one skilled in the art and/or appear hereinafter.

### BRIEF DESCRIPTION OF THE DRAWINGS

The above-mentioned and other features and advantages of this invention, and the manner of attaining them, will become appreciated and be more readily understood by reference to the following detailed description of one embodiment of the invention in conjunction with the accompanying drawings, wherein:

FIG. 1 a block diagram of a conventional scanned antenna array system employing time-delay microwave signal processing;

FIG. 2 is a schematic diagram of one of the time delay stages of FIG. 1 and sub-circuits thereof;

FIG. 3 is a block diagram of one embodiment of a scanned antenna array system of the present invention;

FIG. 4 is a schematic diagram of one of the time delay stages of FIG. 3 and sub-circuits thereof;

FIG. 5 is a schematic diagram of one embodiment of the switches shown in FIG. 4;

FIG. 6 is a graph showing delay time in nanoseconds vs frequency in gigahertz of the time delay stages of the present invention;

FIG. 7 is a graph showing the phase linearity in degrees vs. frequency in gigahertz of the time delay stages of the present invention; and

FIG. 8 is a graph showing the time delay variation in picoseconds vs. frequency in gigahertz between time delay stages of the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE DRAWINGS

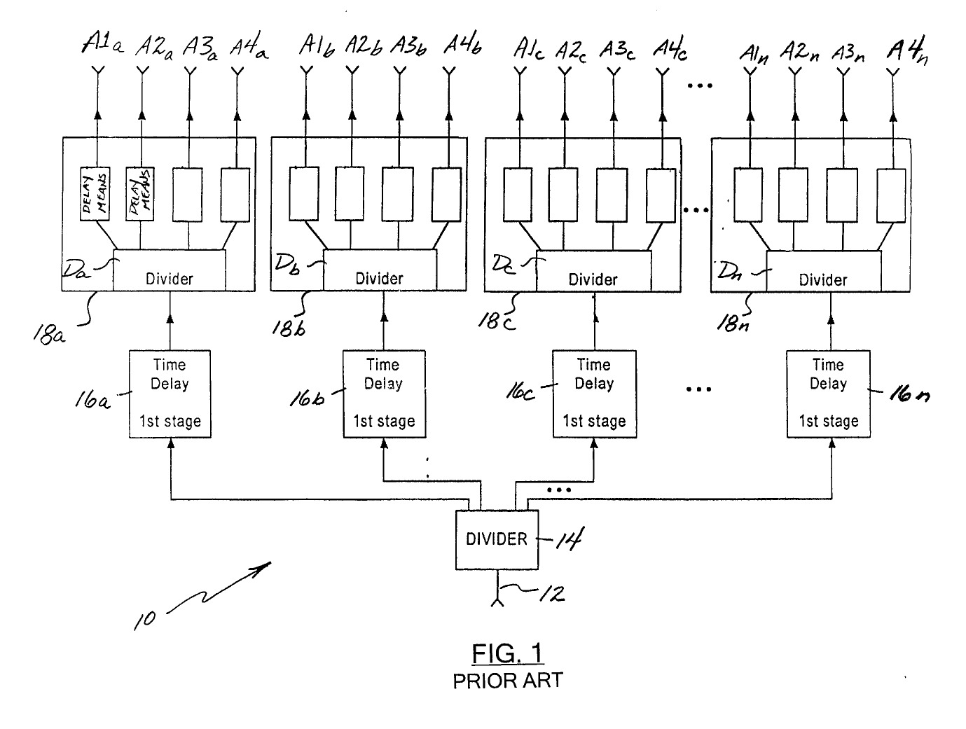

Referring now to the drawings, and particularly to FIG. 1, a block diagram of a conventional scanned antenna array system employing time-delay microwave signal processing is shown. Antenna array system 10 receives microwave input signal 12, which is routed through divider 14 and to a plurality or N number of first delay stages or coarse delay stages 16a, 16b, 16c, . . . 16n. The first/coarse delay stages 16a-16n receive respective RF input signals from divider 14. Generally, each first/coarse delay stage 16a-16b performs coarse beam forming by delaying the RF input signal by a controlled amount of time.

A plurality or N number of second delay stages 18a, 18b, 18c . . . 18n receive the time-delayed RF signals from a corresponding one of first/coarse delay stages 16a-16n. Each of second delay stages 18a-18n include dividers Da, Db, D . . . , Dn, respectively, and time delay means (not referenced) which perform finer or more precise beam forming by further time delaying the RF signal in a controlled and predetermined manner. Second delay stages 18a-18n are coupled to corresponding antenna elements A1a-A4a, A1b-A4b, A1c-A4c and A1n-A4n, respectively, that radiate the time-delayed output signals supplied to each element by the corresponding delay means.

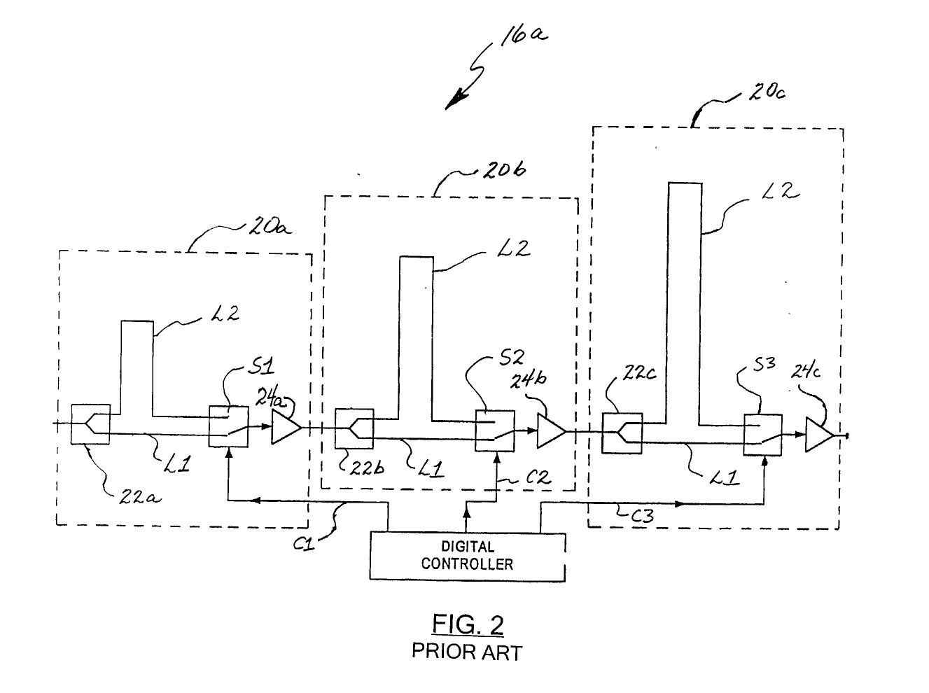

First/coarse delay stages 16a-16n are substantially similar, and therefore a detailed description of one shall serve to describe the structure and functionality of all. Referring now to FIG. 2, a schematic diagram of a conventional first/coarse delay circuit 16a is shown. Time delay circuit 16a is a 3-bit time delay circuit including three sub-circuits 20a, 20b, 20c.

Sub-circuit 20a includes divider 22a that splits the RF input signal between delay lines L1 and L2. The length of line L2 is greater than the length of reference line L1, and thus introduces a time or propagation delay upon the RF signal routed therethrough relative to line L1. Switch S1, in response to control signal C1 from a controller (not referenced), connects one of delay lines L1 and L2 to amplifier 24a. Amplifier 24a amplifies the RF signal to compensate for the insertion loss of switch S1 and the approximate 3 dB loss attributable to divider 22a. Amplifier 24a issues the amplified RF signal to sub-circuit 20b. The RF signal issued by sub-circuit 20a is then processed in a manner substantially similar through sub-circuits 20b and 20c.

Sub-circuits 20a, 20b and 20c are substantially similar to each other in function and design and thus sub-circuits 20b and 20c are not discussed in detail individually. Generally, sub-circuits 20b and 20c include dividers 22b, 22c, respective delay lines L1 and L2, amplifiers 24b, 24c, and switches S2 and S3 receiving control signals C2 and C3, respectively. One distinction between sub-circuits 20a, 20b and 20c is that the ratio of their respective delay lines L2 to L1 increases by a factor of two from sub-circuit 20a to sub-circuit 20b, and from sub-circuit 20b to sub-circuit 20c. Thus, delay line L2 of sub-circuit 20b delays the RF signal twice as long as delay line L2 of sub-circuit 20a. Similarly, delay line L2 of sub-circuit 20c delays the RF signal twice as long as delay line L2 of sub-circuit 20b. Delay lines L1 of each of sub-circuits 20a, 20b, 20c are substantially equal in at least one of length and the amount of time by which they delay the RF signal.

As stated above, each of sub-circuits 20a, 20b and 20c include dividers 22a, 22b and 22c, switches S1, S2 and S3 which receive control signals C1, C2 and C3, and amplifiers 24A, 24b, and 24c, respectively. Thus, each of sub-circuits 20a, 20b and 20c include a plurality of discrete components. Amplifiers 24a, 24b, 24c compensate for the insertion losses associated with dividers 22a, 22b, 22c, respectively, but render the delay sub-circuits 20a, 20b, 20c nonreciprocal.

Although not shown in FIGS. 1 or 2, each of discrete switches S1, S2 and S3 include a plurality of discrete components, such as, for example, inductors and capacitors. These discrete components consume a relatively large amount of space and have known and inherent characteristics, such as, for example, parasitic capacitances and inductances, that can degrade performance of antenna system 10. Thus, sub-circuits 20a, 20b and 20c may require manual tuning in order to achieve and maintain an acceptable level of performance by antenna system 10.

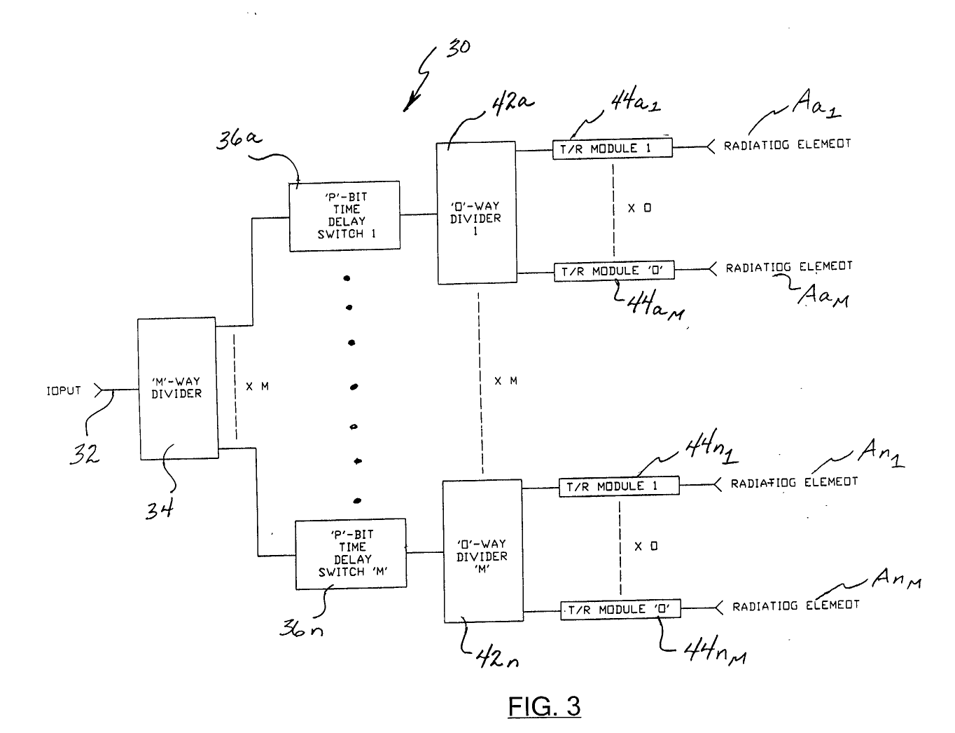

Referring now to FIG. 3, one embodiment of a microwave scanned antenna array system of the present invention is shown. Microwave scanned antenna array system 30 receives RF input signal 32, and includes N-way divider 34, N number of time delay stages 36a, . . . , 36n (only two shown). Antenna array system 30 further includes N number of M-way dividers 42a, . . . , 42n (only two shown), each of which are associated with a corresponding M number of transmit/receive (T/R) modules 44a₁-44a_{M}, 44n₁-44n_{M}, respectively. Generally, antenna array system 30 receives input signal 32, which is routed through N-way divider 34 to each of time delay stages 36a-36n. Delay stages 36a-36n perform coarse beam forming by delaying the RF input signal by a controlled amount of time. The coarse-formed or delayed signals are then supplied to T/R modules 44a₁-44a_{M} through 44n₁-44n_{M} via M-way dividers 42a-42n, respectively. T/R modules 42a-42n each include M number of time delay means (not shown). M-way dividers 42a-42n route the signal supplied to each of T/R modules 42a-42n into their respective M delay means, such as conventional digital phase shift and/or amplifier circuits, that perform the finer or more precise beam forming of the output signal by further time delaying the RF signal in a controlled and predetermined manner as is known in the art. T/R modules 42a-42n each provide M output signals to a corresponding M number of radiating elements Aa₁-Aa_{M} and An₁-An_{M}, respectively, which radiate the time-delayed output signals and thereby form an emitted signal having a predetermined direction and focus, or beam pattern.

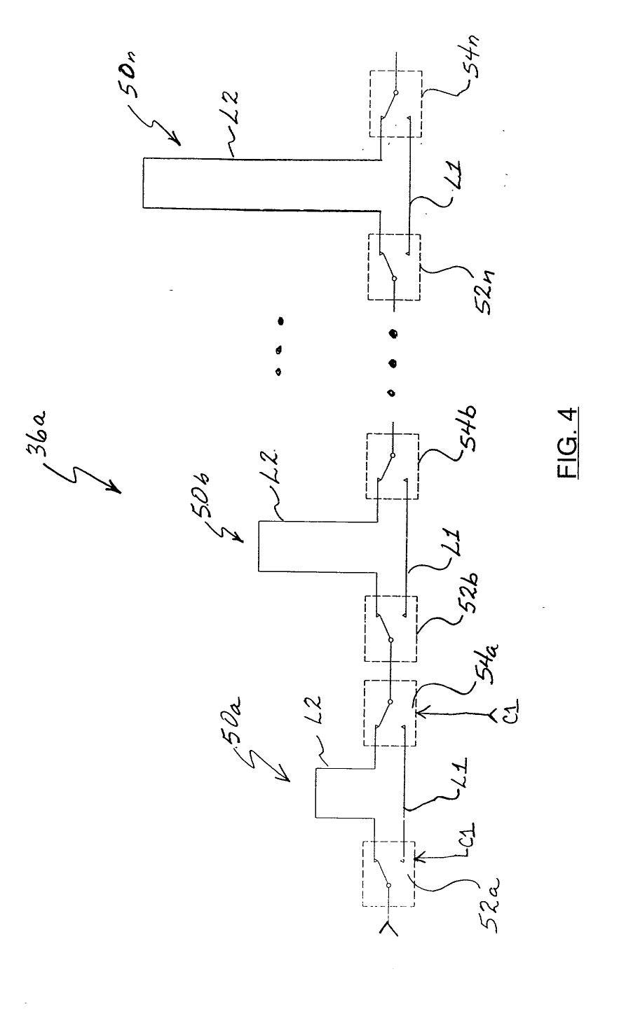

Time delay stages 36a-36n are substantially similar, and therefore a detailed description of one shall serve to describe the structure and functionality of all. Referring now to FIG. 4, an exemplary embodiment of time delay stage 36a is shown. Time delay stage 36a is configured as an n-bit time delay stage, and includes sub-circuits 50a, 50b, . . . , 50n.

Sub-circuit 50a includes a first single-pole double throw (SPDT) switch 52a that routes the RF input signal received from N-way divider 34 through one of a first delay/reference line L1 or a second delay line L2. A second SPDT switch 54a routes the delayed signal from one of delay line L1 or L2 to an output (not referenced) of sub-circuit 50a and, thus, to sub-circuit 50b. Switch 52a, in response to control signal C1, routes the RF signal through an indicated one of first and second delay lines L1 and L2. Switch 54a, in response to control signal C1, connects and/or routes the RF signal to sub-circuit 50b.

Switches 52a-52n and 54a-54n are substantially similar, and therefore a detailed description of one shall serve to describe the structure and functionality of all. Switch 52a is a SPDT integrated circuit monolithic microwave broadband switch, such as, for example, a gallium arsenide-based (GaAs) microwave switch, that operates up to a frequency of approximately 20 gigahertz (GHz). One commercially-available embodiment of a single-pole four throw (SP4T) configuration of such a switch is manufactured by TriQuint Semiconductor of 13510 N. Central Expressway, Dallas, Tex., 75243 as model number TGS2304-SCC.

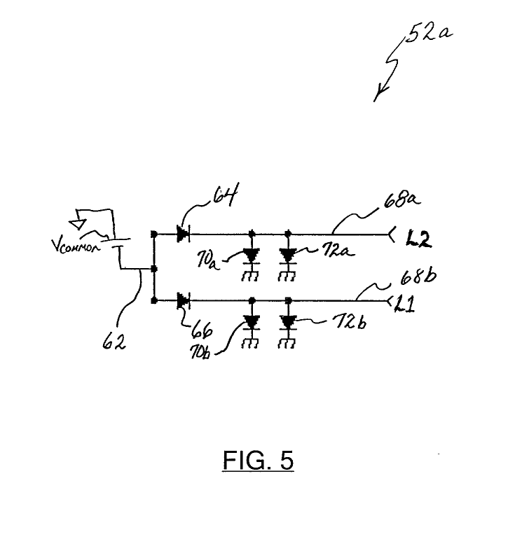

Referring now to FIG. 5, an equivalent schematic diagram of switch 52a is shown. Switch 52a includes input or common arm 62 that is electrically connected to series integrated diodes 64 and 66, and shunt arms 68a and 68b including shunt diodes 70a, 72a and 70b, 72b, respectively. Conventionally, common arm 62 would be connected to ground potential whereas shunt arms 68a, 68b would have a positive bias applied. Integrated monolithic switches, in general, have relatively limited operating power. In order to increase the operating power of switches 52a-52n and 54a-54n, the common arms thereof are each biased with a negative voltage. Thus, as shown in FIG. 5, common arm 62 is electrically connected with a voltage source V_{COMMON} applying a negative voltage thereto. The magnitude of the negative voltage applied to common arm 62 by V_{COMMON} is, for example, from approximately negative 1 volt to a negative maximum as established by the manufacturer's recommendations. Biasing switch 52a in the above-described manner increases the operating power thereof by enabling the input signal applied to common arm 62 to undergo a larger voltage swing.

Delay lines L1 and L2 are preferably configured as conventional microwave delay lines, with the length of each respective delay line L2 increasing by a factor of two relative to delay line L2 of the preceding sub-circuit, as is described more particularly hereinafter. Forming delay lines L1 and L2 as conventional delay lines, rather than integral with the corresponding monolithic integrated switches of the corresponding sub-circuit, enable microwave scanned antenna array system 30 to achieve longer delays relative to integrated delay lines. Integrating the delay lines with the corresponding monolithic integrated switches substantially limits the useable bandwidth of the delay lines that are achievable relative to conventional non-integral delay lines, since the monolithic delay lines which are configured as micro-strips are nonlinear.

As stated above, sub-circuits 50a-50n are substantially similar to each other in function and design and thus sub-circuits 50b-50n are not discussed in detail individually. Generally, each of sub-circuits 50b-50n include corresponding switches 52b-52n and 54b-54n, and each include delay lines L1 and L2. However, a distinction between sub-circuits 50a-50n is that the ratio of the lengths of their respective delay lines L2 to L1 increases by a factor of two from sub-circuit 50a to sub-circuit 50b, and from sub-circuit 50b to sub-circuit 50c (not shown), and so on. Thus, delay line L2 of sub-circuit 50b delays the RF signal twice as long as delay line L2 of sub-circuit 50a. Similarly, delay line L2 of sub-circuit 50c (not shown) delays the RF signal twice as long as delay line L2 of sub-circuit 50b. Delay/reference lines L1 of each of sub-circuits 50a-50n are substantially equal in length and in the amount of time by which they delay the RF signal.

Scanned antenna array system 30 has a substantially reduced number of discrete components relative to a conventional scanned antenna array system. For example, a conventional six-bit time delay sub-circuit requires two switches per bit, each switch having three diodes, for a total of thirty-six discrete switching PIN diodes, whereas a six-bit time delay sub-circuit of scanned antenna array system 30 requires two switches per bit for a total of twelve integrated switches. The reduction in discrete parts also substantially reduces the number of interconnects that must be made, thereby reducing circuit complexity and time required for assembly. Thus, by using integrated switches 52 and 54 the number of discrete components and interconnects required to implement scanned antenna array system 30 is substantially reduced relative to a conventional scanned antenna array system.

Relative to discrete PIN diode switches, the integrated switches are substantially identical to each other in terms of operating characteristics, parametrics, and performance. The variation in the operational characteristics between integrated switches is substantially reduced relative to the variation between discrete PIN diode switches and therefore the integrated switches more closely matched. Thus, the need to manually tune the sub-circuits in order to obtain an acceptable level of performance of antenna system 30 is substantially reduced. Further, since the integrated switches are more closely matched, the need for isolation devices between sub-circuits is substantially reduced.

It should be particularly noted that sub-circuits 50a-50n, and thus time delay stages 36a-36n, include no amplifiers or dividers. As described above, conventional time delay sub-circuits employ amplifiers to compensate for the insertion loss of the dividers. The amplifiers, however, render the conventional time delay sub-circuits non-reciprocal. Amplifiers are not required to compensate for any insertion losses due to dividers in sub-circuits 50a-50n. Therefore sub-circuits 50a-50n are reciprocal.

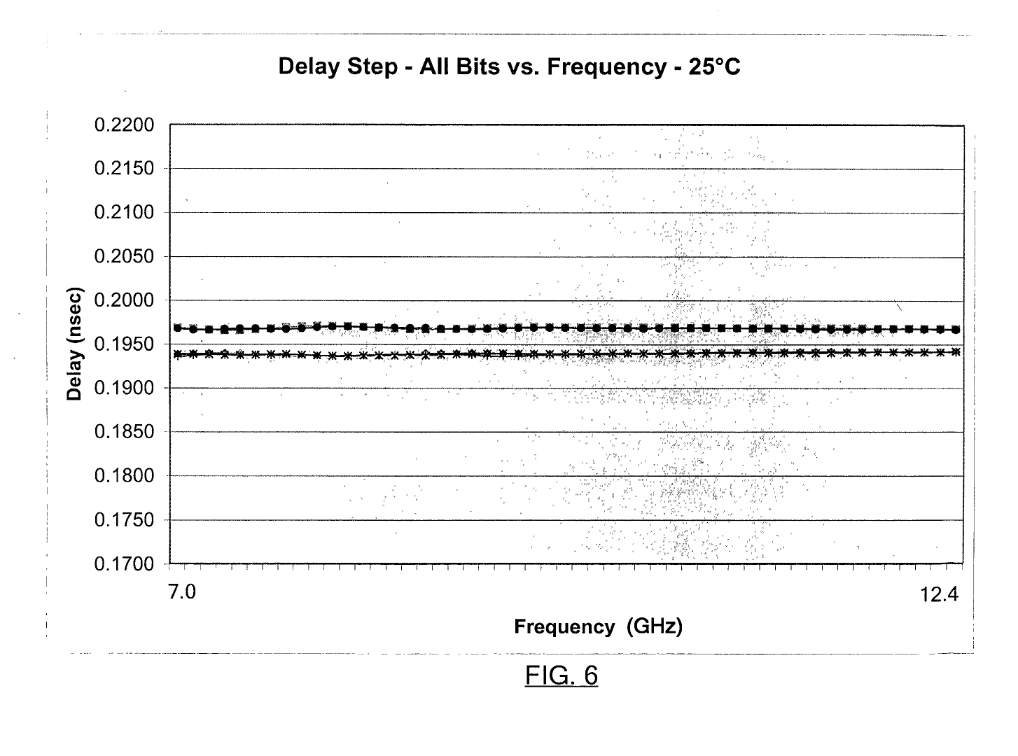

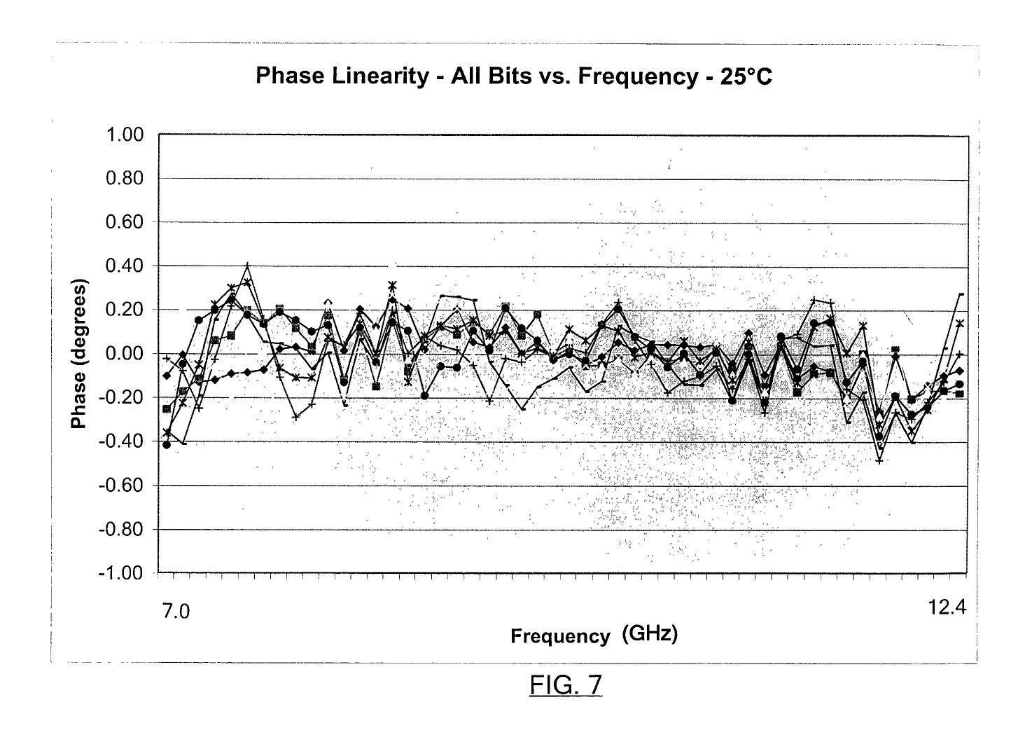

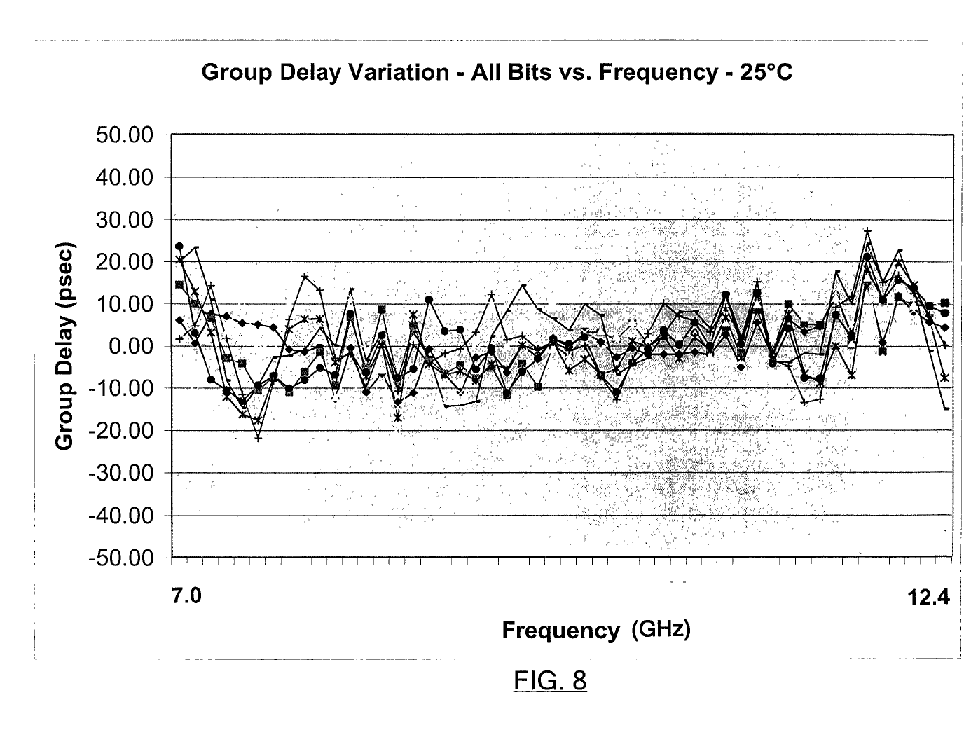

It should further be particularly noted that integrated switches 52a-52n and 54a-54n, and thus delay stages 36a-36n, can operate over a frequency range of from approximately 0.01 to 20 gigahertz with few bandwidth limitations relative to a conventional/discrete time delay stage. More particularly, as seen in FIG. 6, delay stages 36a-36n operate with a generally flat delay time over a frequency range of from approximately 7 GHz to 12.4 GHz (i.e., “X” band). Further, as seen in FIG. 7, delay stages 36a-36n operate with generally constant phase over a frequency range of from approximately 7 GHz to approximately 12.4 GHz. Thus, delay stages 36a-36n have substantially reduced bandwidth limitations relative to conventional delay stages. Moreover, it should be particularly noted that the variation in the delay times of different delay stages, as shown in FIG. 8, is substantially lower than the variation in time delays between different conventional delay stages.

In the embodiment shown, antenna array system 30 is configured with N number of M-way dividers 42a-42n, each of which provide M antennae with time-delayed signals. However, it is to be understood that the present invention can be alternately configured with a varying number of dividers which divide the input signal by a varying number to thereby provide virtually any number of antennae with time-delayed signals.

In the embodiment shown, time delay stages 36a-36n are configured with N number of sub-circuits 50a-50n. However, it is to be understood that time delay stages can be alternately configured, such as, for example, as sub-circuits of a 3-bit, 4-bit or virtually any number of bit configuration.

In the embodiment shown, switches 52a-52n and 54a-54n are configured as SPDT switches. However, it is to be understood that switches 52a-52n and 54a-54n can be alternately configured, such as, for example, single-pole four throw switches.

In the embodiment shown, the common arms of switches 52a-52n and 54a-54n have a negative voltage/bias applied thereto. However, it is to be understood that the bias applied to the common arms of the switches can be varied within the range recommended by the switch manufacturer.

In the embodiment shown, delay lines L1 and L2 are configured as conventional delay lines. However, it is to be understood that delay lines L1 and L2 can be alternately configured, such as, for example, formed on a substrate either integral with or separate from the switches.

While this invention has been described as having a preferred design, the present invention can be further modified within the spirit and scope of this disclosure. This application is therefore intended to cover any variations, uses, or adaptations of the present invention using the general principles disclosed herein. Further, this application is intended to cover such departures from the present disclosure as come within the known or customary practice in the art to which this invention pertains and which fall within the limits of the appended claims.

What is claimed:

1. A scanned antenna array, comprising:
at least one time delay stage, each said time delay stage having at least one time delay sub-circuit, each said time delay sub-circuit including a sub-circuit input and a sub-circuit output, each said time delay sub-circuit comprising:
a first delay line having a first and second end;
a second delay line having a first and second end;
a first diode switch connected to said sub-circuit input, said first diode switch connecting said first end of a selected one of said first and second delay lines to said sub-circuit input; and
a respective second diode switch connected to said sub-circuit output, said second diode switch connecting said second end of said selected one of said first and second delay lines to said sub-circuit output, said sub-circuit output connected to one of another of said time delay sub-circuits or to an output of said time delay stage;
a respective transmit/receive (TR) module coupled to an output of each said time delay stage, each said TR module issuing a respective TR module output signal; and
a plurality of antenna elements coupled to an output of a corresponding one of said TR modules and radiating a respective TR module output signal received therefrom.

2. The scanned antenna array of claim 1, wherein each said first and second diode switch comprises an integrated monolithic P-type semiconductor/Intrinsic/N-type semiconductor (PIN) diode switch.

3. The scanned antenna array of claim 1, wherein each said first and second diode switch includes a respective common arm and at least one respective shunt arm, said common arms of at least one of said first and second diode switches being negatively biased relative to ground potential.

4. The scanned antenna array of claim 1, wherein said first diode switch is responsive to a control signal to connect said first end of one of said first and second delay lines to said sub-circuit input.

5. The scanned antenna array of claim 1, wherein said second diode switch is responsive to a control signal to connect said second end of one of said first and second delay lines to said sub-circuit output.

6. A time-delay stage for use in a scanned antenna array, said time-delay stage including at least one time delay sub-circuit having a sub-circuit input and a sub-circuit output, each said at least one time-delay sub-circuit comprising:
a first delay line having a first and second end;
a second delay line having a first and second end;
a first diode switch connected to said sub-circuit input, said first diode switch connecting said first end of a selected one of said first and second delay lines to said sub-circuit input; and
a second diode switch connected to said sub-circuit output, said second diode switch connecting said second end of said selected one of said first and second delay lines to said sub-circuit output, said sub-circuit output connected to one of another of said time delay sub-circuits or to an output of said time-delay stage.

7. The time-delay stage of claim 6, wherein each of said first and second diode switches comprises an integrated monolithic P-type semiconductor/Intrinsic/N-type semiconductor (PIN) diode switch.

8. The time-delay stage of claim 6, wherein each said first and second diode switch includes a respective common arm and at least one respective shunt arm, said common arms of at least one of sad first and second diode switches being negatively biased relative to ground potential.

9. The time-delay stage of claim 6, wherein said first diode switch is responsive to a control signal to connect said first end of one of said first and second delay lines to said sub-circuit input.

10. The time-delay stage of claim 6, wherein said second diode switch is responsive to a control signal to connect said second end of one of said first and second delay lines to said sub-circuit output.

11. A time delay sub-circuit for use with a time-delay stage of a scanned antenna array, said time delay sub-circuit having a sub-circuit input and a sub-circuit output, said time delay sub-circuit comprising:
a first delay line having a first and second end;
a second delay line having a first and second end;
a first diode switch connected to said sub-circuit input, said first diode switch connecting said first end of a selected one of said first and second delay lines to said sub-circuit input; and
a second diode switch connected to said sub-circuit output, said second diode switch connecting said second end of said selected one of said first and second delay lines to said sub-circuit output, said sub-circuit output configured for being connected to one of another said time delay sub-circuit or to an output of the time-delay stage.

12. The time-delay stage of claim 11, wherein each of said first and second diode switches comprises an integrated monolithic P-type semiconductor/Intrinsic/N-type semiconductor (PIN) diode switch.

13. The time-delay stage of claim 11, wherein each said first and second diode switch includes a respective common arm and at least one respective shunt arm, said common arms of at least one of said first and second diode switches being negatively biased relative to ground potential.

14. The time-delay stage of claim 11, wherein said first diode switch is responsive to a control signal to connect said first end of one of said first and second delay lines to said sub-circuit input.

15. The time-delay stage of claim 11, wherein said second diode switch is responsive to a control signal to connect said second end of one of said first and second delay lines to said sub-circuit output.

16. A method of time-delaying a microwave input signal, said method comprising:
coupling the input signal to a selected one of two delay lines of a delay sub-circuit; and
connecting the selected delay line to one of an input of another delay sub-circuit or to an output of a delay stage.

17. The method of claim 16, wherein said coupling step comprises coupling with a first diode switch the input signal to a first end of the selected delay line.

18. The method of claim 17, wherein said connecting step comprises connecting with a second diode switch a second end of the selected delay line to one of another delay sub-circuit or the output of the delay stage.

19. The method of claim 18, wherein said first and second diode switches comprise corresponding integrated monolithic P-type semiconductor/Intrinsic/N-type semiconductor (PIN) diode switches including a respective common arm and at least one respective shunt arm.

20. The method of claim 19, comprising the further step of applying a negative bias voltage to the common arm of at least one of the first and second diode switches to thereby negatively bias the common arm relative to ground potential.
